(19) United States
(12) Patent Application Publication
(10) Pub. No.: US 2024/0174831 A1
(43) Pub. Date: May 30, 2024

(54) SULFOBETAINE-MODIFIED POLYURETHANE OR POLYUREA FOAM

(71) Applicant: 3M INNOVATIVE PROPERTIES COMPANY, St. Paul, MN (US)

(72) Inventors: Tony R. Carrozzella, Ontario (CA); Kent E. Nielsen, Ontario (CA)

(21) Appl. No.: 17/754,838

(22) PCT Filed: Oct. 15, 2020
(86) PCT No.: PCT/IB2020/059725

§ 371 Date: Apr. 13, 2022

Related U.S. Application Data
(60) Provisional application No. 62/916,518, filed on Oct. 17, 2019.

(51) Int. Cl. C08J 9/228; C08G 18/38; C08J 9/00

(52) U.S. Cl. CPC C08J 9/228; C08G 18/3872; C08J 9/0095; C08J 2381/10

(57) ABSTRACT

A hydrophilic foam comprises a polymer formed from a betaine prepolymer that is a reaction product of a betaine of formula (I) with one or more polyether glycols and a polyfunctional isocyanate compound of formula (II), (I) wherein R¹, R², R³, and R⁴ are each hydrocarbon groups having from 1 to 4 carbon atoms, A⁻ is an anionic functional group, and X⁺ is a cationic atom, (II) wherein R⁵ is a linear or branched aliphatic hydrocarbon group having from 2 to 12 carbon atoms, or a 5- or 6-membered aliphatic or aromatic carbocyclic group having from 5 to 50 carbon atoms, and b is an integer having a value of 1, 2, or 3.

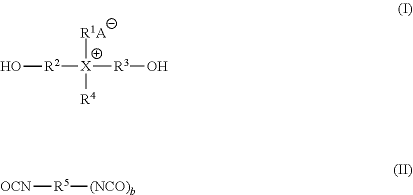

### BACKGROUND

Cellulose materials can be desirable for cleaning sponges because their fibrous nature can lead to a sponge that is structurally strong and resilient when coming into contact with water-based solutions, as is common for a cleaning sponge. Typical pulping processes for making cellulose-based sponge materials can also result in the addition of polar groups to the fibrous matrix of the cellulose material, which can be advantageously hydrophilic and lead to a sponge with good water absorption properties.

There has been considerable interest in the manufacture of hydrocarbon-based polymeric materials to replace cellulosic sponges. For example, there has been a focus on polyurethane-based materials to form the sponge matrix. However, it has been challenging to produce sponges made from polyurethanes or other polymeric materials that have sufficient bulk hydrophilicity and that will rapidly wick water-based liquids up from a surface to be cleaned and that has sufficient structure strength and integrity to maintain an acceptable sponge shape for a relatively long lifetime.

### SUMMARY

The present disclosure describes novel polyurethane or polyurea-based foams that can be used as a sponge for cleaning applications. The polyurethane or polyurea-based foam materials are modified with a zwitterionic material such as a sulfobetaine-based material, which the inventors have found improves hydrophilicity for the modified foam and provides for the formation of a polyurethane-based or polyurea-based sponge with many of the properties that are desirable in cellulose-based sponge materials.

In an example, the present disclosure describes a hydrophilic foam comprising a polymer formed from a betaine prepolymer of formula (I):

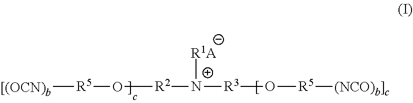

wherein A⁻ is an anionic functional group, R¹, R², and R³ are each hydrocarbon groups having from 1 to 4 carbon atoms, R⁵ is a linear or branched aliphatic hydrocarbon group having from 2 to 12 carbon atoms, or a 5- or 6-membered aliphatic or aromatic carbocyclic group having from 5 to 50 carbon atoms, b is an integer having a value of 1, 2, or 3, and c is the degree of polymerization of the betaine prepolymer, which is an integer having a value of 1-5.

In another example, the present disclosure describes a hydrophilic foam comprising a polymer formed from a betaine prepolymer that is a reaction product of a betaine of formula (I) with one or more polyether glycols and a polyfunctional isocyanate compound of formula (II),

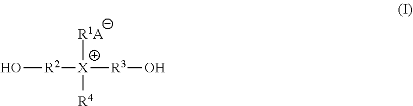

wherein R¹, R², R³, and R⁴ are each hydrocarbon groups having from 1 to 4 carbon atoms, A⁻ is an anionic functional group, and X⁺ is a cationic atom,

OCN—R⁵—(NCO)_{b} (II)

wherein R⁵ is a linear or branched aliphatic hydrocarbon group having from 2 to 12 carbon atoms, or a 5- or 6-membered aliphatic or aromatic carbocyclic group having from 5 to 50 carbon atoms, and b is an integer having a value of 1, 2, or 3.

In another example, the present disclosure describes a method comprising the steps of: (a) reacting a betaine of formula (I) with one or more polyether glycols and a polyfunctional isocyanate compound of formula (II) to provide a hydrophilic prepolymer,

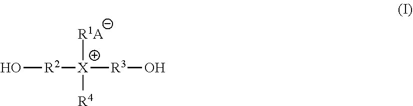

wherein R¹, R², R³, and R⁴ are each hydrocarbon groups having from 1 to 4 carbon atoms, A⁻ is an anionic functional group, and X⁺ is a cationic atom,

OCN—R⁵—(NCO)_{b} (II)

wherein R⁵ is a is a linear or branched aliphatic hydrocarbon group having from 2 to 12 carbon atoms, or a 5- or 6-membered aliphatic or aromatic carbocyclic group having from 5 to 50 carbon atoms, and b is an integer having a value of 1, 2, or 3; and (b) polymerizing and foaming the hydrophilic prepolymer of step (a) to provide a hydrophilic foam.

In another example, the present disclosure describes a method comprising the steps of: (a) reacting a tertiary amine of formula (I) with a cyclic ester,

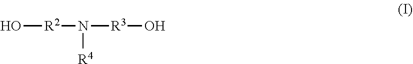

wherein R², R³, and R⁴ are each hydrocarbon groups having from 1 to 4 carbon atoms, to provide a betaine of formula (II),

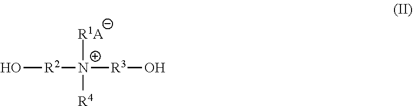

wherein R¹ is a hydrocarbon group having from 1 to 4 carbon atoms; (b) reacting the betaine of formula (II) with one or more polyether glycols and a polyfunctional isocyanate of formula (III),

OCN—R⁵—(NCO)_{b} (III)

wherein R⁵ is a is a linear or branched aliphatic hydrocarbon group having from 2 to 12 carbon atoms, or a 5- or 6-membered aliphatic or aromatic carbocyclic group having from 5 to 50 carbon atoms, and b is an integer having a value of 1, 2, or 3, to provide a prepolymer of formula (IV)

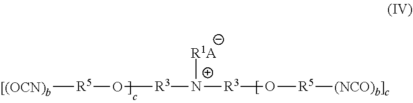

wherein c is the degree of polymerization of the betaine prepolymer, which is an integer having a value of 1-5; and (c) polymerizing and foaming the prepolymer of formula (IV) to provide a hydrophilic foam.

In another example, the present disclosure describes a method comprising the steps of: (a) reacting a betaine of formula (I) with caprolactone of formula (II) to provide a hydrophilic prepolymer,

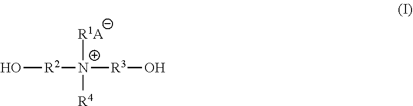

wherein R¹, R², R³, and R⁴ are each hydrocarbon groups having from 1 to 4 carbon atoms, and A⁻ is an anionic functional group,

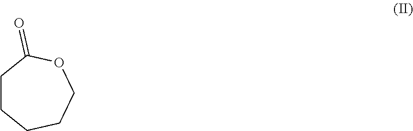

to provide a precursor compound having formula (III),

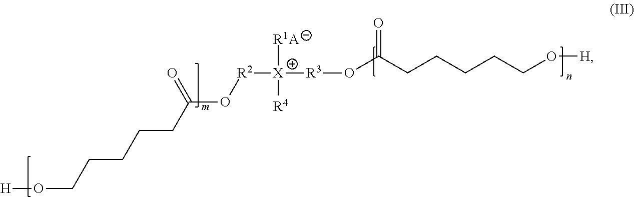

wherein m and n are integers from 1 to 5; and (b) polymerizing and foaming the precursor compound of step (a) to provide a hydrophilic foam.

In another example, the present disclosure describes a method comprising the steps of: (a) reacting a tertiary amine of formula (I) with caprolactone of formula (II),

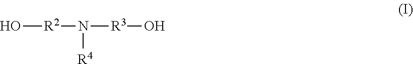

wherein R², R³, and R⁴ are each hydrocarbon groups having from 1 to 4 carbon atoms, and A⁻ is an anionic functional group,

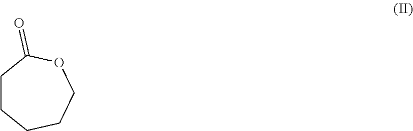

to provide an intermediate compound having formula (III),

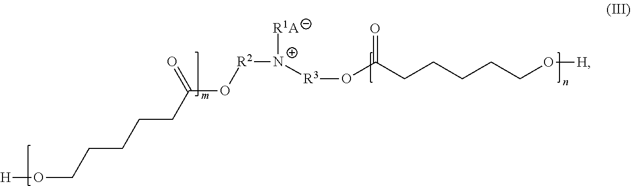

wherein m and n are integers from 1 to 5; (b) reacting the intermediate compound of step (a) with a cyclic ester to form a precursor compound; and (c) polymerizing and foaming the precursor compound of step (b) to provide a hydrophilic foam.

### DETAILED DESCRIPTION

The following detailed description describes specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment”, “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1” is equivalent to “0.0001.”

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In the methods described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

In addition, it is to be understood that the phraseology or terminology employed herein, and not otherwise defined, is for the purpose of description only and not of limitation. Any use of section headings is intended to aid reading of the document and is not to be interpreted as limiting, and information that is relevant to a section heading may occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Polyurethane/Polyurea Foam Materials

A polyurethane or polyurea-based foam material is formed which can be used for various applications. For example, the foam material can be used as a sponge, such as for use in cleaning. In some examples, a polyurethane-based foam is synthesized from isocyanate-terminated polyethyleneoxide, polypropyleneoxide, polyesters, or combinations thereof. In some examples, co-reactants are polyols or polyamines of similar polymeric backbones. Water can also be used as a co-reactant, which can generate a blowing agent, such as carbon dioxide, in addition to generating a crosslinked polymer system. These materials can produce a sponge-like foam material.

However, without modifiers or added functional groups, polyurethane or polyurea-based foamed materials exhibit little hydrophilic character, e.g., they have moderate bulk hydrophilicity but do a poor job at wicking water off surfaces. This lack of desired hydrophilic character is clearly disadvantageous for materials that are desired to be used as a sponge for cleaning, because the resulting sponges will not be good at wicking up liquids from a surface to be cleaned. Also, polyurethane-based and polyurea-based foam materials have been found to naturally possess few of the characteristics associated with cellulose-based sponges that are favorable for cleaning sponges, such as structural strength and integrity to maintain an acceptable sponge shape for a relatively long lifetime.

As is described in more detail below, the present disclosure describes a polyurethane-based or polyurea-based polymer structure with one or more modifier compounds incorporated into the main polymer matrix. In an example, the one or more modifier compounds include a sulphonate group, such as that which is in a sulfobetaine group. In an example, the modifier compound is reacted to form a multivalent molecule such as a polyol. In an example, the modifier compound is reacted via transesterification with a polymeric glycol to form the multivalent molecule.

In an example, the modifier compound has the general formula [1]:

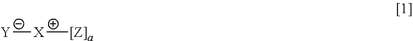

wherein X⁺ comprises an atom of an element that forms a cation in the molecule of the modifier compound, e.g., where the atom forms a local positive charge (e.g., the atom is cationic). In an example, X⁺ is a nitrogen cation (N⁺). In formula [1], Y⁻ is a functional group that is bonded to the X⁺ cationic atom and includes an anionic group, such as a functional group that includes a sulfonate group (e.g., —SO₃⁻). In formula [1], Z is functional group that is also bonded to the X⁺ atom. The number a represents the number of Z groups that are bonded to the X⁺ atom, which is equal to one less than the valence of the particular X⁺ atom in the molecule (because one of the bonds to the X⁺ atom is taken up by the Y⁻ group). For example, if X⁺ is a cationic atom with a valence of 4, such as a nitrogen cation (N⁺), then a is 3, meaning that there are three (3) separate Z groups bonded to the X⁺ atom. Formula [2] is a modified form of formula [1] showing this example, with the three Z groups designated as Z¹, Z², and Z³.

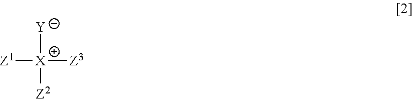

wherein each Z group, e.g., the Z¹ group, the Z² group, and the Z³ group, comprises a hydrocarbon-based moiety having from 1 to 20 carbon atoms. Each Z group can be a saturated hydrocarbon group (e.g., an alkyl-based group) or an unsaturated hydrocarbon group (e.g., an alkenyl-based group or alkynyl-based group), and can comprise an unsubstituted hydrocarbon group (e.g., a hydrocarbon that includes only carbon and hydrogen atoms) or can be substituted with one or more groups, such as a hydroxyl, halogen, nitrile, nitro, cyano, alkoxy, or amino groups. In an example, each Z group can be the same or different from any of the other Z groups, e.g., Z¹ can be different from or the same as Z² and can be different from or the same as Z³, and Z² can be different from or the same as Z³.

In an example, Y⁻ comprises a hydrocarbon-based moiety having from 1 to 4 carbon atoms with the anionic group bonded to one of the carbon atoms, e.g., in the form of —R¹A⁻, as shown in formula [3]:

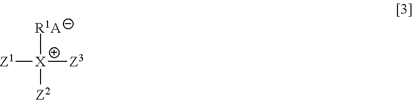

where R¹ is a hydrocarbon chain having from 1 to 4 carbon atoms, and A⁻ is the anionic group. R¹ can be a saturated hydrocarbon group or an unsaturated hydrocarbon group and can comprise an unsubstituted hydrocarbon or can be substituted with one or more groups, such as a hydroxyl, halogen, nitrile, nitro-, cyano-, alkoxy-, or amino group. In an example, the anionic group A⁻ is at a terminal end of the hydrocarbon chain R¹. Examples of anionic groups that can comprise A⁻ include, but are not limited to, a sulfonate anion group (e.g., (e.g., —SO₃⁻), a carboxylate anion group (COO⁻), or a phosphonate anion group (PO₄⁻).

In formulas [1], [2], and [3], the molecule has a net neutral charge, e.g., with the +1 charge of the X⁺ cation being canceled out by the −1 charge of the Y⁻ group in formulas [1] and [2], such as from the −1 charge of the A⁻ group in formula [3]. While the overall net charge of the molecule is neutral (e.g., with a charge of 0), because there is some space between the X⁺ cation and the A⁻ group due to the length of the R group that is positioned between them, the molecule acts as a zwitterion. As used herein, “zwitterion” refers to a molecule that includes two or more functional groups with at least one of the groups having a positive charge and at least one of the other groups having a negative charge, but where the net charge for the entire molecule is zero.

In some examples, the modifier compound is a betaine molecule, which is a specific type of zwitterion. As used herein, “betaine” refers to a molecule with a positively charged cationic functional group that bears no hydrogen atoms, such as in the case when the X⁺ cation is a nitrogen cation (e.g., the N⁺ in a quaternary ammonium cation) or a phosphorus cation (e.g., the P⁺ in a quaternary phosphonium cation), and a negatively charged anionic functional group in the same molecule. In this way, a betaine is a specific type of zwitterion. In examples where the anionic functional group results from the inclusion of a sulfonate group, e.g., where A⁻ is a —SO₃⁻ group, the molecule can be referred to as a “sulfobetaine.” The present inventors have found that the ionic character of betaine molecules, and in particular sulfobetaine molecules, has a beneficial impact on the physical properties of a polymeric system when the betaine molecule is incorporated therein. For example, the presence of the sulfobetaine molecule can improve hydrophilicity and mechanical strength of a polymer foam system such that the polymer foam acts more like traditional cellulose-based sponges. In addition, because betaine molecules are net neutral with respect to electrical charge, they can be more soluble in polymer matrices than charged molecules that contain only anionic or only cationic functionality. This enhanced solubility can lead to an enhancement of the material engineering window. Sulfobetaine compounds have also been found to have biological activity, such that the compounds can add functionality to a sponge that incorporates them, such as a non-fouling or antimicrobial function.

In an example, at least two of the Z groups in the molecule of formula [3] include a hydroxyl group (e.g., with the general formula —R—OH) such that the entire molecule is a polyol having formula [4]:

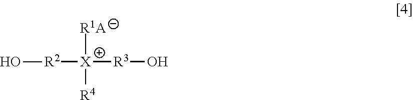

where R² and R³ are a hydrocarbon group having from 2 to 4 carbon atoms, wherein the hydrocarbon group is either a saturated or unsaturated hydrocarbon and can be an unsubstituted or substituted hydrocarbon. R⁴ is a hydrocarbon group having from 1 to 20 carbon atoms. As described above, in some examples X⁺ is an ammonium ion N⁺, so that the betaine of formula [4] becomes the compound of formula [5]:

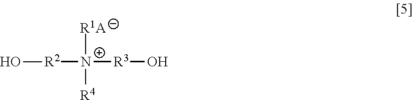

The compound of formula [5] can be reacted in the presence of one or more polyether glycols, such as poly(ethylene glycol) as in formula [6] or a poly(ethylene glycol) and poly(propylene glycol) block copolymer as in formula [7]:

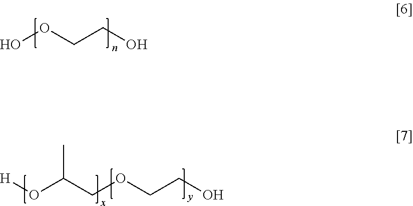

and with a polyfunctional isocyanate compound of formula [8]:

OCN—R⁵—(NCO)_{b} [8]

where b is an integer having a value of 1, 2, or 3, and R⁵ is a linear or branched aliphatic hydrocarbon group having from 2 to 12 carbon atoms, or 5- and 6-membered aliphatic and aromatic carbocyclic groups having from 5 to 50 carbon atoms. Examples of polyfunctional isocyanates of formula [8] that can be used for the present disclosure include, but are not limited to: a methylene diphenyl diisocyanate (“MDI”) such as 4,4′-methylene diphenyl diisocyanate, toluene diisocyanate (“TDI”), hexamethylene diisocyanate, isophorone diisocyanate, 3,5,5-trimethyl-1-isocyanato-3-isocyanatomethyl-cyclohexane, and 4,4′,4″-triisocyanatotriphenylmethane, or those described in U.S. Pat. Nos. 3,700,643 and 3,600,359, the entire disclosures of which are incorporated herein.

The reaction of the compound of formula [5] with the one or more polyether glycols and the polyfunctional isocyanate of formula [8] produces an isocyanate-terminated polyurethane prepolymer of formula [9]:

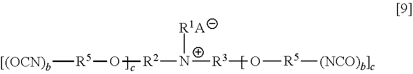

This reaction proceeds according to Reaction [A]:

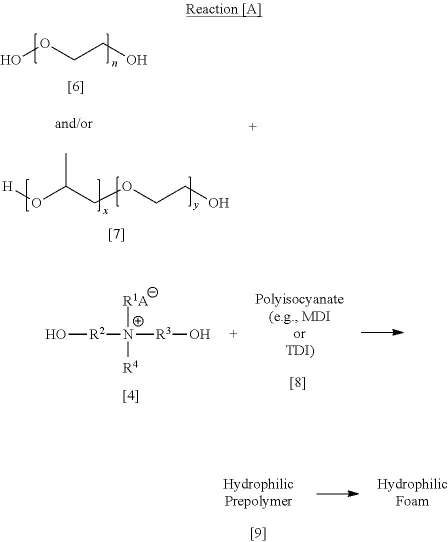

The isocyanate-terminated polyurethane prepolymer of formula [9] can be incorporated into a polyurethane foam by known polymerization and foaming methods.

For example, the isocyanate-terminated polyurethane prepolymer [9] can be mixed with water, a surfactant (such as nonionic alkylphenyl polyether alcohol), and a polymerization catalyst (such as 2,2′-dimorpholinodiethylether, also referred to as DMDEE), which forms a polyurethane foam. Further details of methods of forming polyurethane foams from other prepolymer compounds are described in U.S. Pat. No. 4,638,017, titled “HYDROPHILIC POLYURETHANE/POLYUREA SPONGE,” issued on Jan. 20, 1987; U.S. Publication No. 2017/0247521 A1, titled “HYDROPHILIC OPEN CELL FOAMS WITH PARTICULATE FILLERS,” published on Aug. 31, 2017; and U.S. Publication No. US 2017/0245724, titled “HYDROPHILIC OPEN CELL FOAMS,” published on Aug. 31, 2017, the entire disclosures of which are incorporated herein by reference.

In an example, the final polyurethane-based foam includes a weight percentage per batch of the betaine modifier. The phrase “betaine modifier equivalent,” as used herein, refers to the reaction product of one molecule of the polyurethane prepolymer of formula [9], which was formed after reacting the betaine modifier compound of formula [5] according to Reaction [A], after the polyurethane prepolymer has been incorporated into a polyurethane-based foam, as described above.

The polyurethane-based foam materials formed from the polyurethane prepolymer of formula [9], e.g., that is formed by incorporating the betaine modifier compound of formula [5], demonstrates many of the physical properties that are desirable in cellulose-based sponges, such as hydrophilicity, structural integrity, stability over a wide range of pH, and also can be prepared to have additional properties that are not generally exhibited by cellulose-based sponges, such as anti-microbial activity. Surprisingly, the inventors have found that the use of a betaine modifier, such as betaine of formula [4] (which, for example, can be a sulfobetaine or a carboxybetaine), has a higher affinity for water (e.g., is more hydrophilic) than other ionic modifier compounds that have been tried. For example, as summarized in Table 4 below, the sulfobetaine-modified foams absorbed more water than the sodium sulfonate anionic modified foams and, further, the betaine modified foams demonstrated this property at a lower density. The polyurethane-based foam materials of the present disclosure also form a cross-linked polymer system, which has good structural integrity when subjected to aqueous solutions such as those experienced by cleaning sponges.

### Synthesis of Betaine Modifier Compounds

As described above, a modifier compound such as the polyol containing betaine of formula [5] can be incorporated into a polyurethane prepolymer, such as via Reaction [A] to form polyurethane prepolymer [9], which, as described above, can then be incorporated into a polyurethane foam via known or yet to be discovered foaming methods. In an example, the betaine compound of formula [5] can be formed from many different reactant compounds. In general, the betaine compound of formula [5] is formed by reacting a 5- or 6-membered cyclic ester compound, such as a sultone or a lactone, with a tertiary amine of formula [10].

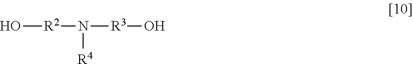

where A⁻, R¹, R², R³, and R⁴ are as defined above.

In an example, the reaction of the tertiary amine of formula [10] with an exemplary cyclic sultone compound, 1,3-propane sultone, to form a sulfobetaine product. This reaction proceeds according to Reaction [B].

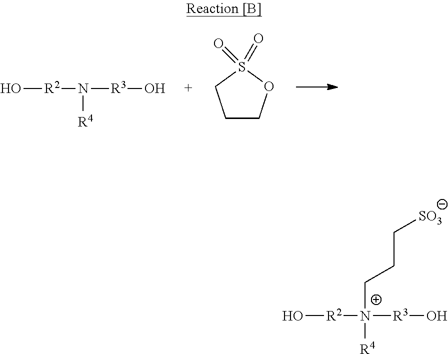

As can be seen, Reaction [B] results in a sulfobetaine compound that falls under the general formula [5] wherein R¹ is an n-propyl group (—(CH₂)₃—) and the resulting —R¹A⁻ is a —(CH₂)₃SO₃⁻ group formed by the ring-opening reaction of the 1,3-propane sultone with the tertiary amine of formula [10].

In another example, the tertiary amine of formula [10] is reacted with an exemplary cyclic lactone compound, γ-butyrolactone, to form a carboxybetaine product.

This reaction proceeds according to Reaction [C]:

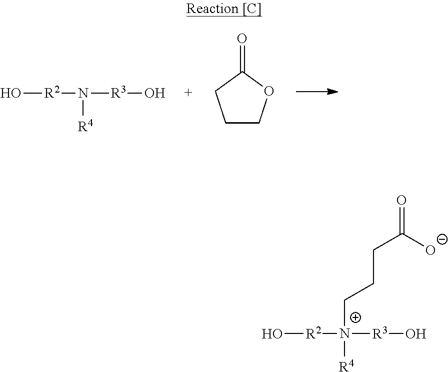

As can be seen, Reaction [C] results in a carboxybetaine compound that falls under the general formula [5], wherein R¹ is an n-propyl group (—(CH₂)₃—) and the resulting —R¹A⁻ is a —(CH₂)₃COO⁻ group formed by the ring-opening reaction of the γ-butyrolactone with the tertiary amine of formula [10].

Various examples of more specific chemistries that can be used to form a betaine-modifier compound according to formula [5] will now be described in more detail.

Betaine Derived from Alkoxylated Amines

In an example, the tertiary amine of formula [10] is an alkoxylated amine wherein one or more of R², R³, and R⁴ comprises an alkoxylated group having the general formula [11]:

—((CH₂)ₙO)ₘH [11]

where m is an integer from 1 to 5 and n may be 2, 3, or 4. In an example, one or more of R², R³, and R⁴ are specifically an ethoxylated group having the general formula [12]:

—(CH₂CH₂O)ₘH [12]

In an example, R⁴ in formula [10] comprises an ether group having the formula [13]:

—R⁶—O—R⁷ [13]

where R⁶ comprises a linear aliphatic hydrocarbon of from 1 to 20 carbon atoms, and R⁷ comprises a hydrocarbon of from 1 to 20 carbon atoms, wherein R⁷ can be linear or branched, substituted or unsubstituted, and saturated or unsaturated.

In an example where both R² and R³ comprise the ethoxylated group of formula [11] and R⁴ comprises the ether group of formula [13], the tertiary amine that is reacted with the 5- or 6-membered cyclic ester compound has the formula [14]:

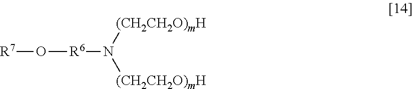

The tertiary amine of formula [14] can be reacted with a 5- or 6-membered cyclic ester compound, as described above with respect to Reactions [B] and [C]. For example, the tertiary amine of formula [14] can be reacted to form a sulfobetaine having the formula [14].

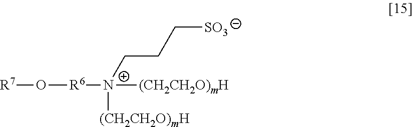

Reaction [D] shows a reaction that forms the sulfobetaine of formula [15] by reacting the tertiary amine of formula [14] with 1,3-propane sultone.

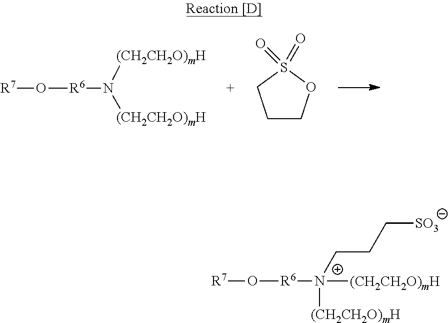

Similarly, the tertiary amine of formula [14] can be reacted to form a carboxybetaine having the formula [16].

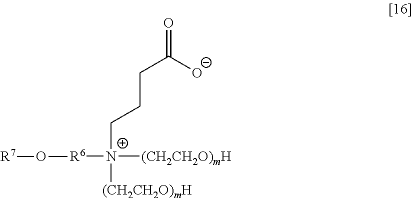

Reaction [E] shows a reaction that forms the carboxybetaine of formula [16] by reacting the tertiary amine of formula [14] with γ-butyrolactone.

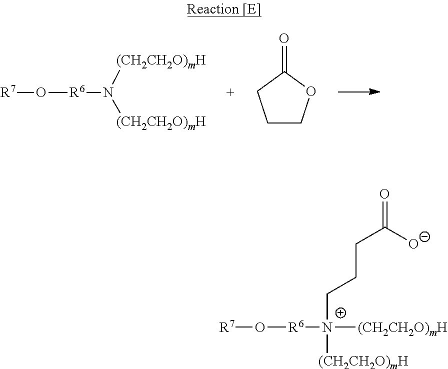

In some examples, the tertiary amine of formula [14] that is reacted with the 5- or 6-membered cyclic ester compound is a commercially-available amine, such as one of the several ether amines sold under the TOMAMINE trade name by Evonik Industries AG, Essen, Germany, for example the E-SERIES TOMAMINES such as TOMAMINE E-14-2, TOMAMINE E-14-5, TOMAMINE E-17-2, TOMAMINE E-17-5, or combinations thereof.

In an example, the tertiary amine of formula [10], such as the amines with formula [14], are placed into solution, e.g., by dissolving into a solvent, before reacting the tertiary amine with the 5- or 6-membered cyclic ester compound. In an example, the solvent used can dissolve both the tertiary amine and the cyclic ester compound. Examples of solvents that can be used to dissolve the tertiary amine and the cyclic ester compound include, but are not limited to, acetonitrile (CH₃CN), and ethanol.

Betaine Derived from Aza-Michael Adduct

In an example, the tertiary amine of formula [10] is a tertiary amine formed via an Aza-Michael addition reaction with the general formula [17].

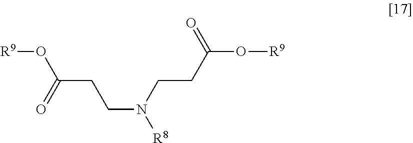

wherein R⁸ is a saturated alkyl group having from 1 to 4 carbon atoms and R⁹ is an alkyl group (the alkyl group may also contain a hydroxyl functionality) having from 1 to 10 carbon atoms.

Reaction [F] shows the generic reaction of an Aza-Michael addition.

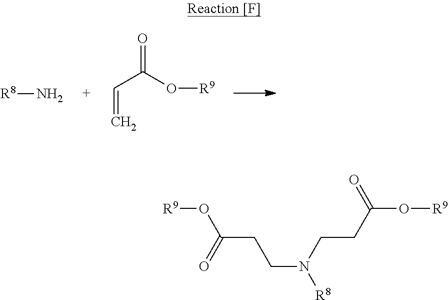

The adduct product of Reaction [F] is the tertiary amine of formula [17], which can then be reacted with a 5- or 6-membered cyclic ester compound similar to as described above. For example, the Aza-Michael Adduct of formula [17] can be reacted with 1,3-propane sultone to form a sulfobetaine having the general formula [18].

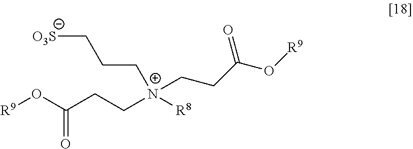

This reaction is represented by Reaction [G].

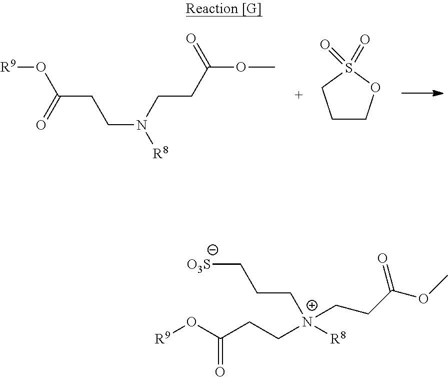

Similarly, the reaction of the Aza-Michael Adduct of formula [15] with γ-butyrolactone forms a carboxybetaine having the general formula [19].

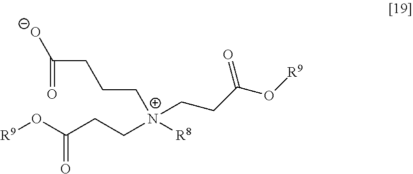

This reaction is represented by General Reaction [H].

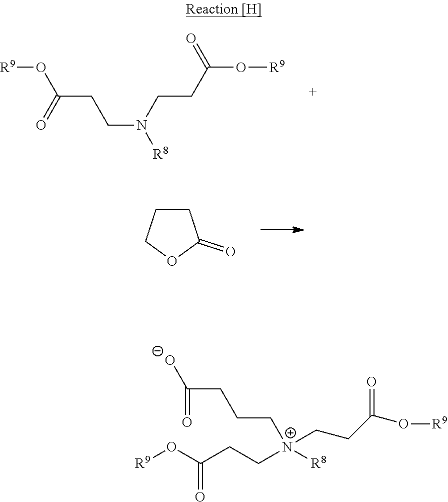

In an example, the betaine modifier compound produced from an Aza-Michael adduct, such as the sulfobetaine of formula [18] or the carboxybetaine of formula [19], is prepared by a two-step reaction process. For example, the sulfobetaine of formula [18] can be prepared by first synthesizing an Aza-Michael adduct of formula [17] via Reaction [F], followed by reaction of the Aza-Michael adduct of formula [17] with a sultone via Reaction [G] to form the sulfobetaine of formula [18]. Similarly, the carboxybetaine of formula [19] can be prepared by first synthesizing an Aza-Michael adduct of formula [17] via Reaction [F], followed by reaction of the Aza-Michael adduct of formula [17] with a lactone via Reaction [H] to form the carboxybetaine of formula [19].

In an example, the first reaction step of this two-step reaction process (e.g., Reaction [F] to form the Aza-Michael adduct of formula [17]) is performed in a first reaction vessel, and the second reaction step (e.g., Reaction [G] to form the sulfobetaine of formula [18] or Reaction [H] to form the carboxybetaine of formula [19]) is performed in a second reaction vessel, sometimes referred to as a “two-pot reaction.” In another example, both the first reaction step and the second reaction step are performed in the same reaction vessel, although the first and second reaction steps can be separated in time, sometimes referred to as a “one-pot reaction.”

Foam Generated from Renewable Caprolactone

In an example, a polyurethane foam derived from a betaine compound can include a component that is renewable and biodegradable. In an example, a renewable and biodegradable component that is used to modify the final polyurethane can include caprolactone, which has the formula [20].

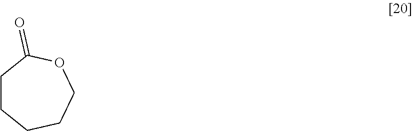

In an example, the caprolactone of formula [20] is then reacted with the betaine compound of formula [5], for example with any of the examples of betaines described above such as the sulfobetaines of formulas [15] and [18] or the carboxybetaines of formulas [16] and [19]. In an example, the reaction of the caprolactone of formula [20] with the betaine of formula [5] proceeds according to Reaction [I].

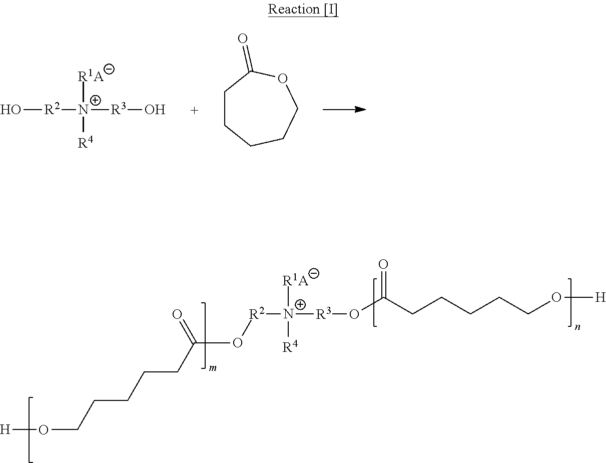

where n and m are the degree of polymerization for the reaction product, which can be an integer from 1 to 5. As can be seen from Reaction [I], the reaction product of the caprolactone and the betaine is an caprolactone-modified precursor compound of formula [21].

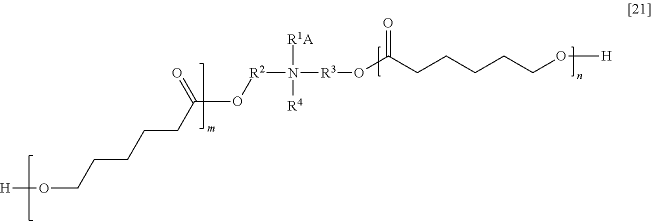

In one example, the caprolactone-modified precursor compound of formula [21] is formed by a two-step process wherein the betaine compound of formula [5] is formed in a first reaction step, for example via Reaction [B] or Reaction [C]. Then, the betaine compound of formula [5] is reacted with caprolactone to form the caprolactone-modified precursor compound of formula [21], for example via Reaction [I], in a second reaction step.

In another example, the caprolactone-modified precursor compound of formula [21] is formed by first reacting the caprolactone of formula [20] with a tertiary amine, such as the tertiary amine of formula [10], described above, which forms an intermediate compound having the formula [22].

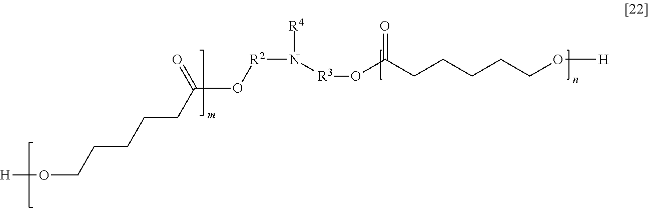

where n and m are the same as defined above for Reaction [I]. In an example, the formation of the intermediate compound of formula [22] proceeds according to Reaction [J].

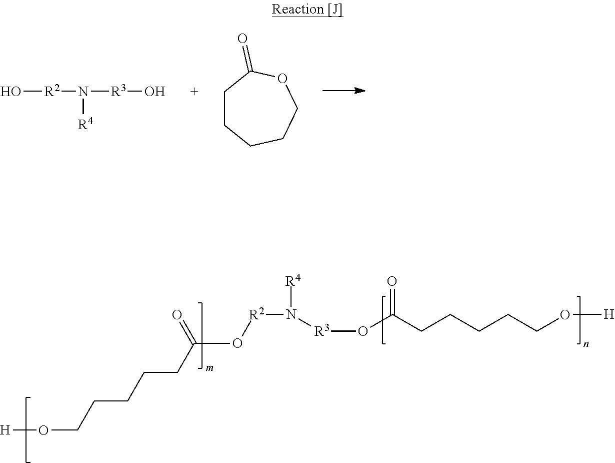

Next, the intermediate compound of formula [22] can be reacted with a 5- or 6-membered cyclic ester compound, such as a sultone or a lactone, to form an example oligomeric precursor of formula [21]. In one example, the intermediate compound of formula [22] is reacted with 1,3-propane sultone to arrive at an oligomeric precursor having formula [23].

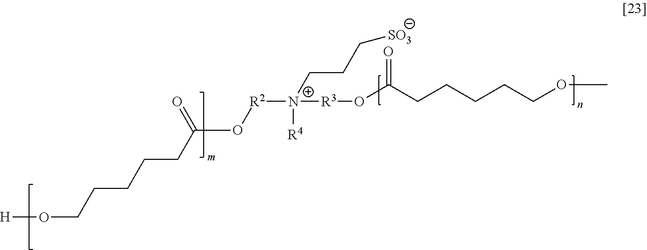

The reaction of the intermediate compound of formula [22] with 1,3-propane sultone proceeds according to Reaction [K].

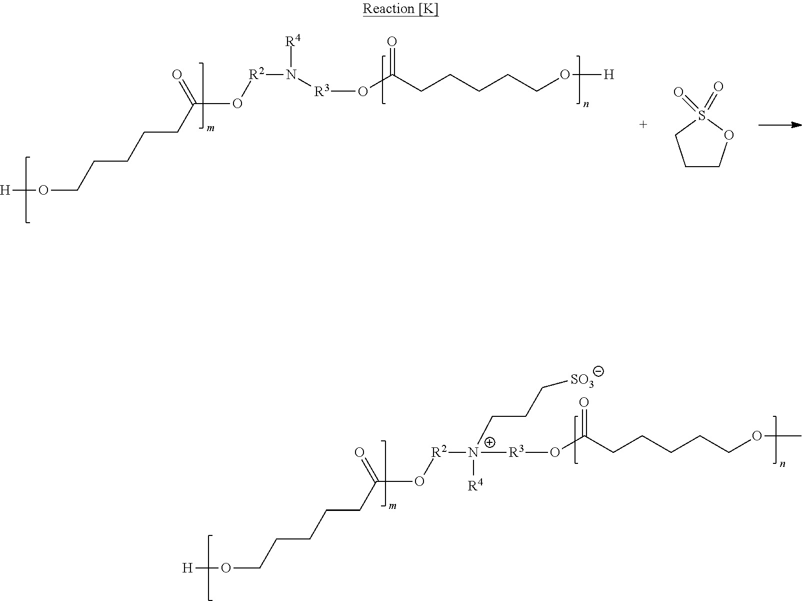

In an example, the two-step process of Reactions [J] and [K] can proceed in the same reaction vessel, also referred to as a “one-pot process.” For example, the reactants for Reaction [J], i.e., a tertiary amine and a 5- or 6-membered cyclic ester compound, can be combined in a reaction vessel in an appropriate solvent so that Reaction [J] can proceed. After Reaction [J] is allowed to proceed to or near completing, caprolactone can be added to the same reaction vessel so that Reaction [K] can proceed to provide for the formation of the caprolactone-modified precursor compound of formula [21].

In another example, after Reaction [J] that forms the intermediate compound of formula [22], the intermediate compound [22] can be reacted with γ-butyrolactone rather than 1,3-propane sultone to arrive at an oligomeric precursor having formula [24]:

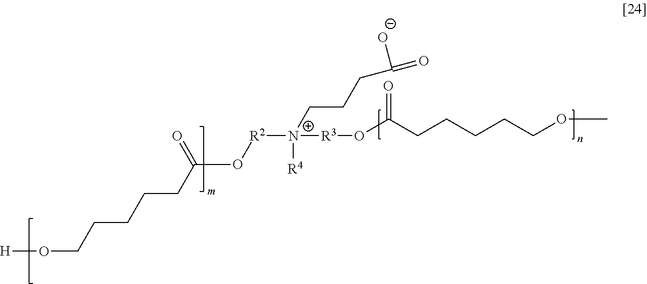

where n and m are the same as defined above for Reaction [I].

The reaction of the intermediate compound of formula [22] with γ-butyrolactone proceeds according to Reaction [L]:

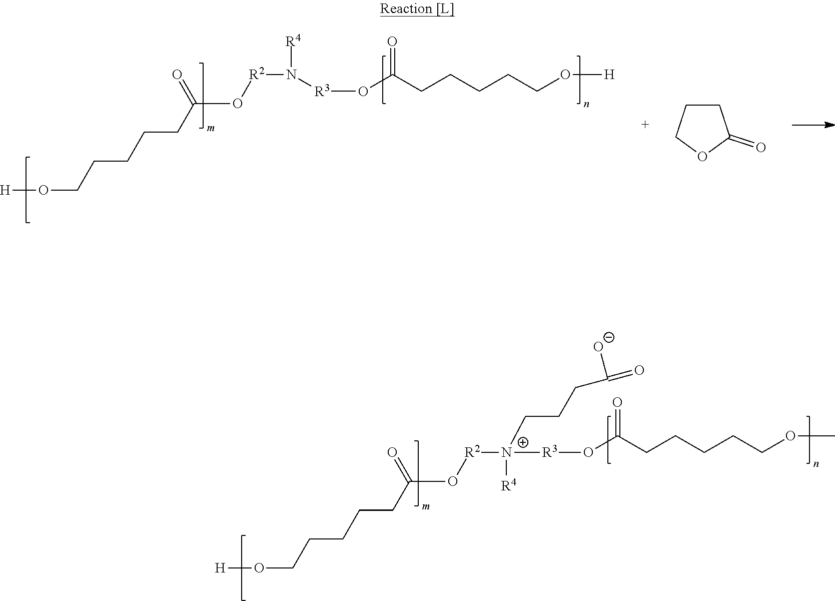

As with Reactions [J] and [K], the combination of Reactions [J] and [L] can proceed in the same reaction vessel, e.g., as a “one-pot process,” or they can be split and performed in two separate vessels, e.g., as a “two-pot process.”

The caprolactone-modified intermediate compound of formula [21], formula [23], or formula [24] can be incorporated into a polyurethane-based compound via similar methods to those described above for the polyurethane prepolymer compound of formula [9], e.g., under reaction conditions similar to those of Reaction [A] and/or to those described in U.S. Pat. No. 4,638,017, titled “HYDROPHILIC POLYURETHANE/POLYUREA SPONGE,” issued on Jan. 20, 1987.

In an example, the polyurethane foam produced from the caprolactone-modified precursor compound of formula [21] can include some or all of the benefits described above for the betaine-modified polyurethane foams described above, e.g., hydrophilic, anti-microbial, chemically stable over a wide range of pH, and mechanically stable when subjected to water and aqueous solutions. In addition to these benefits, the polyurethane foam produced from the caprolactone-modified precursor compound of formula [21] is formed from a renewable biodegradable component; i.e., the caprolactone. A polyurethane-based foam made from the caprolactone-modified precursor of formula [21] is expected to have a lower melting point than previously known polyurethane-based foams, which can allow the ion containing material (e.g., the caprolactone-modified precursor of formula [21]) to be blended or solubilized into other polyols or reactants.

Further details regarding the incorporation of caprolactone into polyurethane can be found in Zhang et al., Renewable High-Performance Polyurethane Bioplastics Derived from Lignin Poly(F-caprolactone), ACS Sustainable Chem. Eng., 2017, 5(5), at pp. 4276-84, the entire disclosure of which being incorporated herein by reference.

### EXAMPLES

Various embodiments of the present invention can be better understood by reference to the following Examples which are offered by way of illustration. The present invention is not limited to the Examples given herein.

### Examples 1-4

Each of EXAMPLES 1-4 involve the reaction of an ethoxylated tertiary amine with 1,3-propane sultone. The ethoxylated tertiary amines of EXAMPLES 1-4 have the general formula [25]:

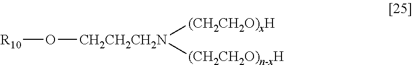

where R₁₀ is an alkyl radical and n is the total number of moles of ethylene oxides oxide that was reacted to form the tertiary amine that is used in each of EXAMPLES 1-4. R₁₀ and n can vary for each of the tertiary amines that are reacted in EXAMPLES 1-4. Each of the tertiary amines of EXAMPLES 1-4 are ethoxylated amines sold under the TOMAMINE E-SERIES trade name by Evonik Industries AG, Essen, Germany.

The ethoxylated amines with the general formula [25] were each reacted with 1,2-propane sultone, as is described above with respect to Reaction [D].

### Example 1

The ethoxylated amine sold under the trade name TOMAMINE E-14-5 by Evonik Industries was reacted with a sultone to form an ammonium sulfobetaine. TOMAMINE E-14-5 is described by its manufacturer as poly (5) oxyethylene isodecyloxypropylamine, where R₁₀ in formula [25] is a branched decane (C₁₀H₂₁). 22.43 g, or about 0.05 mol, of the TOMAMINE E-14-5 was dissolved in 20 mL of acetonitrile and transferred into a 50 mL round-bottomed flask. 6.16 g, or about 0.05 mol, of 1,3-propane sultone was dissolved in 1.5 mL of acetonitrile and the resulting solution was then added directly to the 50 mL round-bottomed flask. The reaction mixture was stirred with a magnetic stir bar and kept at a temperature of 90° C. for 1 week. After the week was done, there was evidence of a waxy solid on the edge of the flask. The solvent was removed under reduced pressure to yield a viscous liquid.

### Example 2

The ethoxylated amine sold under the trade name TOMAMINE E-14-2 by Evonik Industries was reacted with a sultone to form an ammonium sulfobetaine. TOMAMINE E-14-2 is described by its manufacturer as bis-(2-hydroxyethyl) isodecyloxypropylamine, where R₁₀ in formula [25] is a branched decane (C₁₀H₂₁). 31.0 g, or about 0.05 mol, of the TOMAMINE E-14-2 was dissolved in 20 mL of acetonitrile and transferred into a 100 mL round-bottomed flask. 6.16 g, or about 0.05 mol, of 1,3-propane sultone was dissolved in 1.5 mL of acetonitrile and the resulting solution was then added directly to the 100 mL round-bottomed flask. The reaction mixture was stirred with a magnetic stir bar and kept at a temperature of 85° C. for 16.5 hours. At that point, the reaction mixture had become very viscous, so an additional 25 mL of acetonitrile was added to the 100 mL round-bottomed flask and the reaction was allowed to proceed for an additional 3.5 hours, for a total of 24 hours reaction time. The solvent was removed under reduced pressure to yield a high viscosity product with the consistency of taffy.

### Example 3

The ethoxylated amine sold under the trade name TOMAMINE E-17-2 by Evonik Industries was reacted with a sultone to form an ammonium sulfobetaine. TOMAMINE E-17-2 is described by its manufacturer as bis-(2-hydroxyethyl) isotridecyloxypropylamine, where R₁₀ in formula [25] is a branched tridecane (C₁₃H₂₇). 34.5 g, or about 0.1 mol, of the TOMAMINE E-17-2 was dissolved in 20 mL of acetonitrile and transferred into a 100 mL round-bottomed flask. 12.21 g, or about 0.1 mol, of 1,3-propane sultone was dissolved in 1.5 mL of acetonitrile and the resulting solution was then added directly to the 100 mL round-bottomed flask. The reaction mixture was stirred with a magnetic stir bar and kept at a temperature of 85° C. Within 30 minutes, the magnetic stirrer stopped spinning due to an increase in viscosity of the reaction mixture. An additional 25 mL of acetonitrile was added to the 100 mL round-bottomed flask and the reaction was allowed to proceed for an additional 23.5 hours, for a total of 24 hours reaction time. The solvent was removed under reduced pressure to yield a high viscosity product with the consistency of taffy.

### Example 4

The ethoxylated amine sold under the trade name TOMAMINE E-17-5 by Evonik Industries was reacted with a sultone to form an ammonium sulfobetaine. TOMAMINE E-17-5 is described by its manufacturer as poly (5) oxyethylene isotridecyloxypropylamine, where R₁₀ in formula [25] is a branched tridecane (C₁₃H₂₇). 48.5 g, or about 0.1 mol, of the TOMAMINE E-17-5 was dissolved in 20 mL of acetonitrile and transferred into a 100 mL round-bottomed flask. 12.21 g, or about 0.1 mol, of 1,3-propane sultone was dissolved in 1.5 mL of acetonitrile and the resulting solution was then added directly to the 100 mL round-bottomed flask. The reaction mixture was stirred with a magnetic stir bar and kept at a temperature of 85° C. and an additional 25 mL of acetonitrile was added to ensure a low enough viscosity for continued stirring of the reaction mixture. The reaction was allowed to proceed for 24 hours in total. The solvent was removed under reduced pressure to yield a low viscosity product.

### Analysis of Reaction Products of Examples 1-4

The reaction products of EXAMPLES 1-4 were analyzed by Karl-Fischer titration to determine the potential of the intermediates to absorb moisture and as an early metric to provide hydrophilic properties to a polyurethane foam.

Prior to its conversion to the sulfobetaine, the tertiary amine used in EXAMPLE 1 (TOMAMINE E-14-5) was titrated twice and found to have 940 ppm and 1000 ppm water present (or 0.1 wt % water). The sulfobetaine reaction product of EXAMPLE 1 was allowed to sit on the lab bench under existing environmental conditions for one week. After this time period, two samples of the sulfobetaine reaction produced in EXAMPLE 1 were titrated and found to have a moisture content of 6.62 wt. % and 6.66 wt %.

The reaction product sultones of EXAMPLES 2, 3, and 4 were titrated in similar manner (e.g., by first allowing the reaction product sultones to sit on a lab bench for one week). The resulting moisture content of each reaction product is shown in Table 1.

TABLE 1
Moisture Content of Sulfobetaine Reaction
Products from Ethoxylated Amine Reactants

| Reaction | Ethoxylated Amine | Moisture Content |
|---|---|---|
| Product | Reactant | (After 1 week) |
| EXAMPLE 1 | TOMAMINE E-14-5 | 6.64 wt % (Avg.) |
| EXAMPLE 2 | TOMAMINE E-14-2 | 6.0 wt % |
| EXAMPLE 3 | TOMAMINE E-17-2 | 5.0 wt % |
| EXAMPLE 4 | TOMAMINE E-17-5 | 4.0 wt % |

### Example 5

In this example, the tertiary amine reactant that is reacted with a sultone to form a sulfobetaine was synthesized via an Aza-Michael addition reaction. 7.3 g, or about 0.1 mol, of N-butylamine was placed in a 50 mL round-bottomed flask and stirred at ambient temperature with a magnetic stirrer. 23.6 g, or about 0.2 mol, of 2-hydroxyethyl acrylate was transferred into a dropping funnel. The N-hydroxyethyl acrylate was then added into the round-bottomed flask dropwise over the course of 30 minutes. The round-bottomed flask became warm to the touch. After all of the 2-hydroxyethyl acrylate had been added, the reactants were heated to 60° C. and held at that temperature for 2 hours. The N-butylamine and the 2-hydroxyethyl acrylate proceeding according to Reaction [M].

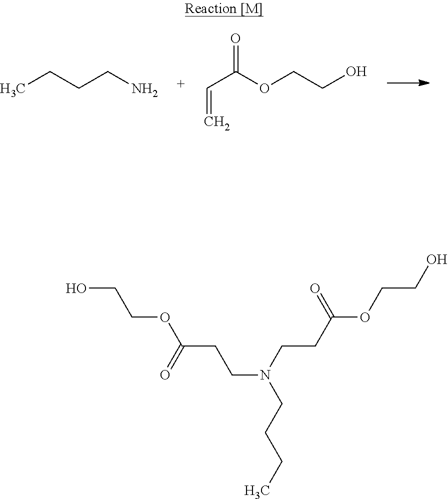

14.08 g, or about 0.069 mol, of the Aza-Michael reaction product of Reaction [M] was dissolved in 125 mL of acetonitrile in a 250 mL round-bottomed flask. 8.43 g, or about 0.069 mol, of 1,3-propane sultone was dissolved in 10 mL of acetonitrile. The resulting solution was added dropwise from a dropping funnel to the 250 mL round-bottomed flask that contained the solution of the Aza-Michael reaction product. After the 1,3-propane sultone was added, the reactants were heated to 80° C. and held at that temperature for 24 hours. The round-bottomed flask was then cooled to ambient temperature and the acetonitrile was removed under reduced pressure to yield the sulfobetaine product produced according to Reaction [N].

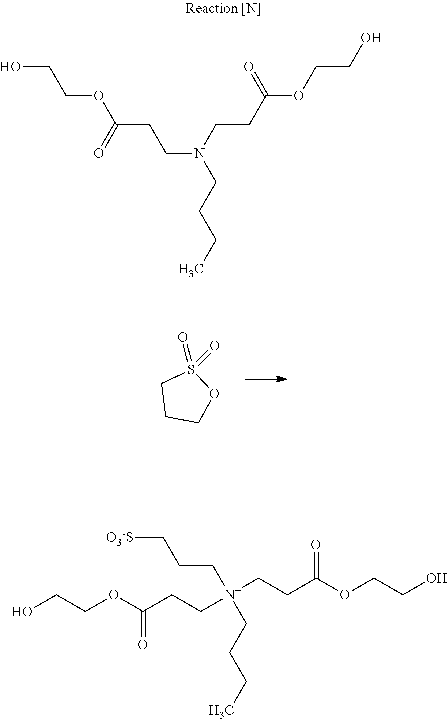

### Example 6

This example is similar to EXAMPLE 5 in that the tertiary amine reactant that is reacted with a sultone was synthesized via Aza-Michael addition. However, rather than forming the Aza-Michael reaction product in a first reaction vessel and then forming the final sulfobetaine product in a second reaction vessel (e.g., a so-called “two-pot reaction”), this example performed both reactions in the same reaction vessel (e.g., a so-called “one-pot reaction”).

7.3 g, or about 0.1 mol, of N-butylamine was placed in a 50 mL round-bottomed flask. 20 mL of ethanol was added, and the contents of the round-bottomed flask was stirred at ambient temperature. Then, 23.3 g, or about 0.2 mol, of 2-hydroxyethyl acrylate was weighed and dissolved in 5 mL of ethanol. The resulting solution was added into a dropping funnel and added to the round-bottomed flask dropwise over the course of 20 minutes. The round-bottomed flask became warm to the touch. After all of the 2-hydroxyethyl acrylate solution was added to the round-bottomed flask, the reactants were heated to 75° C. and kept at that temperature for 2.5 hours. Fourier-transform infrared spectroscopy (FTIR) confirmed completion of the reaction to the Aza-Michael reaction product of Reaction [M].

12.15 g, or about 0.1 mol, of 1,3-propane sultone was dissolved in 13 mL of ethanol. A few crystals of 2,6-Di-tert-butyl-4-methoxyphenol was added to the round-bottomed flask followed by the 1,3-propane sultone/ethanol solution. The reaction mixture was heated to a temperature of 80° C. and maintained at that temperature for 20 hours. The reaction mixture was then cooled to ambient temperature and the ethanol was removed from the round-bottomed flask under reduced pressure.

There was a faint smell of 2-hydroxyethyl acrylate, so the contents were washed three times with 25 mL portions of hexane. The resulting product was a viscous liquid that was light yellow in color.

### Example 7

16.17 g, or about 0.1 mol, of N-butyldiethanolamine was dissolved in 100 mL of acetonitrile in a 250 mL round-bottomed flask. 12.15 g, or about 0.1 mol, of 1,3-propane sultone was dissolved in 10 mL of acetonitrile and transferred into a dropping funnel. The sultone was added dropwise over the course of 20 minutes. After all the sultone was added, the reaction mixture was heated to 80° C. and held at that temperature for 24 hours. The reaction mixture was cooled to ambient temperature and the acetonitrile was removed under reduced pressure to yield the betaine product. The reaction produced a sulfobetaine product according to Reaction [0].

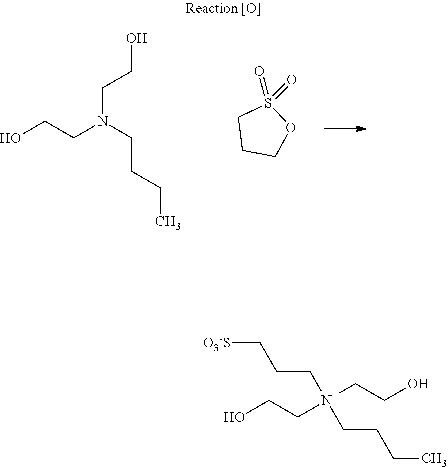

### Example 8

4.0 g, or about 0.055 mol, of N-butylamine was placed in a 50 mL round-bottomed flask. 10 mL of ethanol was added to the round-bottomed flask and the resulting mixture was stirred at ambient temperature. 15.8 g, or about 0.2 mol, of 4-hydroxybutyl acrylate was dissolved in 100 mL of ethanol. The resulting solution was added dropwise from a dropping funnel to the round-bottomed flask over the course of 30 minutes. The reaction mixture became warm to the touch. After all of the 4-hydroxybutyl acrylate/ethanol solution was added to the round-bottomed flask, the reaction mixture was heated to 70° C. and held at that temperature for 5 hours. FTIR analysis confirmed completion of the reaction. The ethanol was removed under reduced pressure. The reaction of the N-butylamine and the 4-hydroxybutyl acrylate proceeded according to Reaction [P].

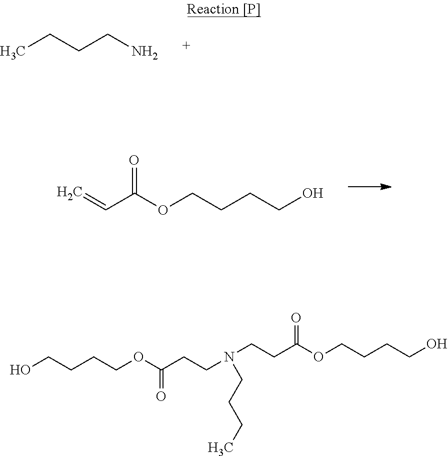

Next, 15 mL of acetonitrile was added to the reaction mixture, followed by 1,3-propane sultone with an equivalence relative to the reaction product from Reaction [P] of 0.95. The reaction mixture was heated to 70° C. and held at that temperature for 48 hours. This reaction produced a sulfobetaine product according to Reaction [Q].

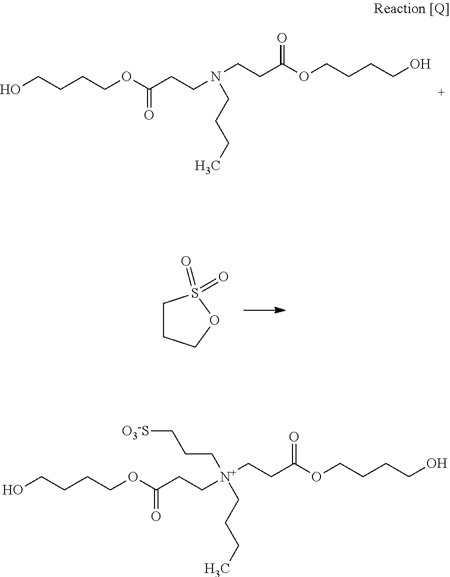

The reaction mixture was cooled to ambient temperature and the acetonitrile was removed under reduced pressure. There was a faint smell of 4-hydroxybutyl acrylate. The product was a viscous liquid that was light yellow in color. Nuclear magnetic resonance (NMR) analysis indicated the presence of the reaction product of Reaction [Q].

### Example 9

11.92 g, or about 0.1 mol, of N-methyldiethanol was dissolved in 100 mL of acetonitrile in a 250 mL round-bottomed flask. 12.15 g, or about 0.1 mol, of 1,3-propane sultone was dissolved in 10 mL of acetonitrile and the resulting solution was placed into a dropping funnel where it was added dropwise into the N-methyldiethanol solution in the round-bottomed flask over the course of 20 minutes. The reaction mixture was then heated to 80° C. and held at that temperature for 24 hours.

The N-methyldiethanol and the 1,3-propane sultone reacted according to Reaction [R] to produce a sulfobetaine reaction product.

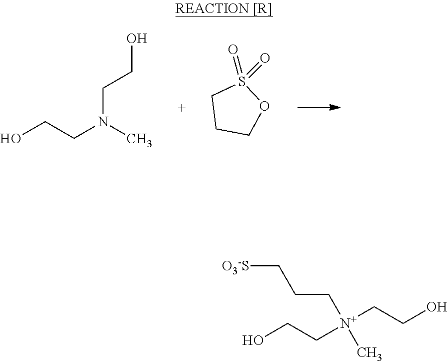

The sulfobetaine reaction product precipitated from the solution in the round-bottomed flask as a function of time. After the 24 hour heating period, the reaction mixture was cooled to ambient temperature and the sulfobetaine reaction product was separated from the solution via filtration, followed by air drying of the sulfobetaine reaction product.

The separated sulfobetaine reaction product was combined with 5.07 g, or about 0.044 mol, of caprolactone, 2 drops of a liquid-based catalyst sold under the trade name METATIN KATALYSATOR 740 by The Dow Chemical Co., Midland, MI, USA, and 20 mL of toluene in a round-bottomed flask to provide a reactant mixture. The reactant mixture was heated to 100° C. and kept at that temperature for 6 days. It was observed that the sulfobetaine reaction product from Reaction [R] was not initially soluble in the toluene, but the solid sulfobetaine was dissolved over time as the reactant mixture was heated. The mixture was then cooled to ambient temperature and the toluene was removed under reduced pressure to produce a waxy solid. The sulfobetaine and the caprolactone reacted according to Reaction [S] to produce the waxy solid reaction product.

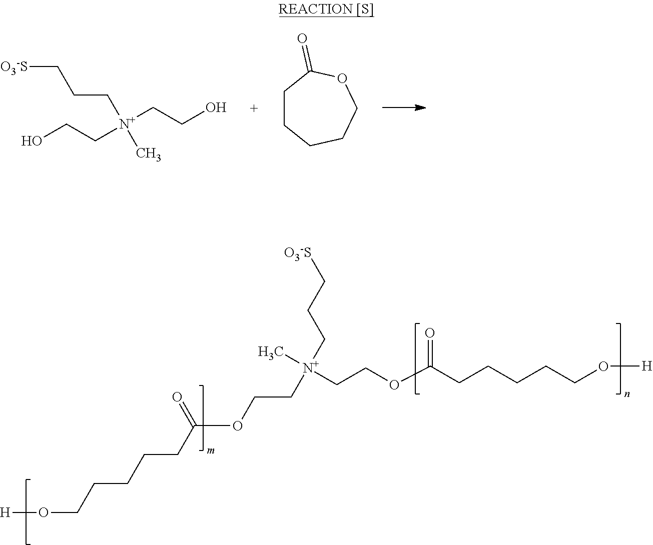

### Example 10

11.92 g, or about 0.1 mol, of N-methyldiethanol was combined with 45.65 g, or about 0.4 mol, of caprolactone, 2 drops of METATIN KATALYSATOR 740 liquid catalyst, and 50 mL of toluene in a round-bottomed flask to provide a reactant mixture. The reactant mixture was heated to 90° C. and held at that temperature for 2 days, after which time the mixture was cooled to ambient temperature and the toluene was removed under reduced pressure. The reaction of the N-methyldiethanol and the caprolactone proceeded according to Reaction [T].

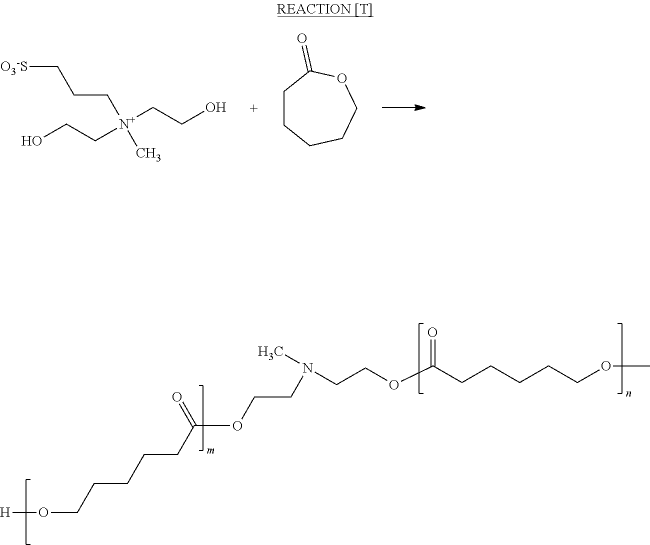

Next, 50 mL of acetonitrile was added to the round-bottomed flask, followed by 12.21 g, or about 0.1 mol, of 1,3-propane sultone. The mixture was then heated to 85° C. and held at that temperature for 24 hours, after which time the round-bottomed flask was cooled to ambient temperature and the acetonitrile was removed under reduced pressure. The resulting product was a dark-colored, viscous oil-like substance. The reaction of the reaction product of Reaction [T] with the 1,3-propane sultone proceeded according to Reaction [U] to provide the dark viscous oil-like product.

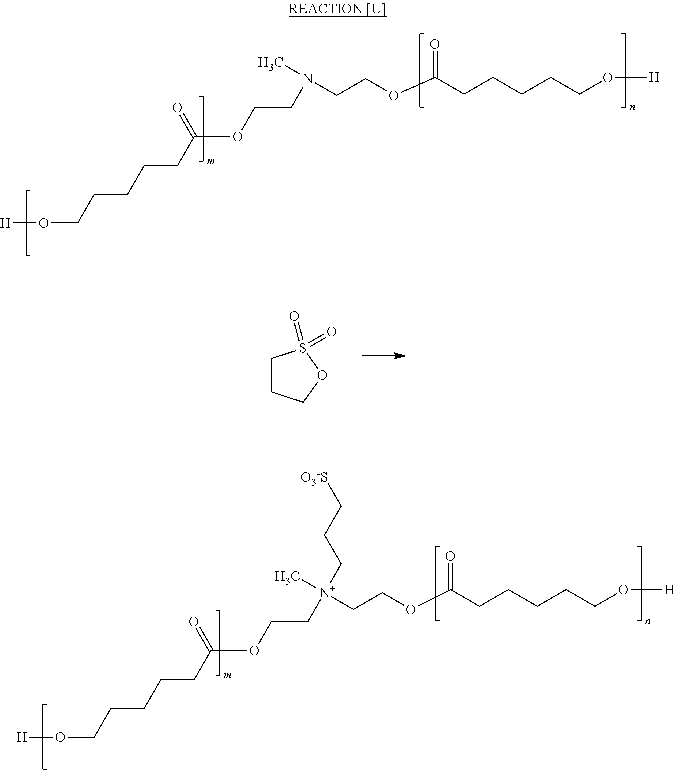

### Example 11

20 g, or about 0.045 mol, of the ethoxylated amine sold under the trade name TOMAMINE E-14-5 by Evonik Industries was dissolved in 55 g of polyethylene glycol sold under the trade name CARBOWAX 600 by The Dow Chemical Co. The resulting solution was placed in a 250 mL round-bottomed flask, to which was added 5.37 g, or about 0.044 mol, of 1,3-propane sultone. The reaction mixture was stirred with a magnetic stir bar while the mixture was heated to 90° C. and held at that temperature for 24 hours. As the reaction mixture was at the 90° C. reaction temperature, the viscosity of the solution increased, and it changed color from a slight yellow to an orange.

### Example 12

40 g, or about 0.09 mol, of the ethoxylated amine sold under the trade name TOMAMINE E-14-5 (Evonik Industries) was dissolved in 50 g of polyethylene glycol (CARBOWAX 600, The Dow Chemical Co.). The resulting solution was placed in a 250 mL round-bottomed flask, to which was added 10.75 g, or about 0.088 mol, of 1,3-propane sultone. The reaction mixture was stirred with a magnetic stir bar while the mixture was heated to 90° C. and held at that temperature for 24 hours.

### Example 13

60 g, or about 0.135 mol, of the ethoxylated amine sold under the trade name TOMAMINE E-14-5 (Evonik Industries) was dissolved in 25 g of polyethylene glycol (CARBOWAX 600, The Dow Chemical Co.). The resulting solution was placed in a 250 mL round-bottomed flask, to which was added 16.1 g, or about 0.132 mol, of 1,3-propane sultone. The reaction mixture was stirred with a magnetic stir bar while the mixture was heated to 90° C. and held at that temperature for 24 hours.

The specific amounts of each reactant in each sulfobetaine blend of EXAMPLES 11, 12, and 13 are shown in TABLE 2. The weight percentage of sulfonate groups (e.g., —SO³⁻) in each sulfobetaine blend was also calculated, and the results are also shown in TABLE 2.

TABLE 2
Sulfobetaine Blend Formulations

| | EXAMPLE 11 | EXAMPLE 12 | EXAMPLE 13 |
|---|---|---|---|
| Tomamine E-14-5 (g) | 20 | 40 | 60 |
| Propane Sultone (g) | 5.37 | 10.75 | 16.1 |
| Carbowax 600 (g) | 55 | 50 | 25 |
| % SO3 | 4.39 | 6.55 | 10.48 |

The reaction between the TOMAMINE E-14-5 ethoxylated amine and the 1,3-propane sultone in each of EXAMPLES 11-13 proceeds according to Reaction [V] to form an ammonium sulfobetaine reaction product.

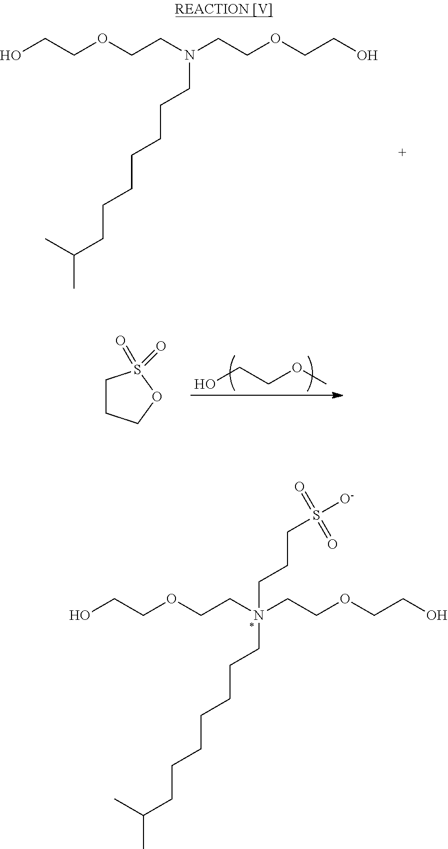

Although the viscosity of the reaction mixture increased, the reactants and the sulfobetaine reaction product both stayed in solution, indicating that the sulfobetaine reaction product can be dissolved in polyethylene glycol.

Reaction [V] in EXAMPLES 11-13 is substantially the same as the reaction of TOMAMINE E-14-5 and 1,3-propane sultone in EXAMPLE 1. The primary difference between the reaction in EXAMPLE 1 and Reaction [V] in EXAMPLES 11-13 is that in EXAMPLE 1, the reactants were dissolved in acetonitrile, while in EXAMPLES 11-13, polyethylene glycol was used to form the reaction solution. The dissolving of the reactants and the resulting sulfobetaine reaction product in polyethylene glycol can be advantageous because, as described above, polyethylene glycol can be one of the reactants used to convert a sulfobetaine to a hydrophilic prepolymer which can, in turn, be turned into a hydrophilic foam material, e.g., the polyethylene glycol solvent can also act as the polyether glycol in Reaction [A].

### Example 14

The ethoxylated amine sold under the trade name TOMAMINE E-14-5 by Evonik Industries is dissolved in polyethylene glycol sold under the trade name CARBOWAX 600 by The Dow Chemical Co. The resulting solution is placed in a round-bottomed flask, to which is added lactone. The reaction mixture is stirred with a magnetic stir bar and heated to 90° C. and held at that temperature for 24 hours. The reaction between the TOMAMINE E-14-5 ethoxylated amine and the lactone proceeds according to Reaction [W] to form an ammonium carboxybetaine reaction product.

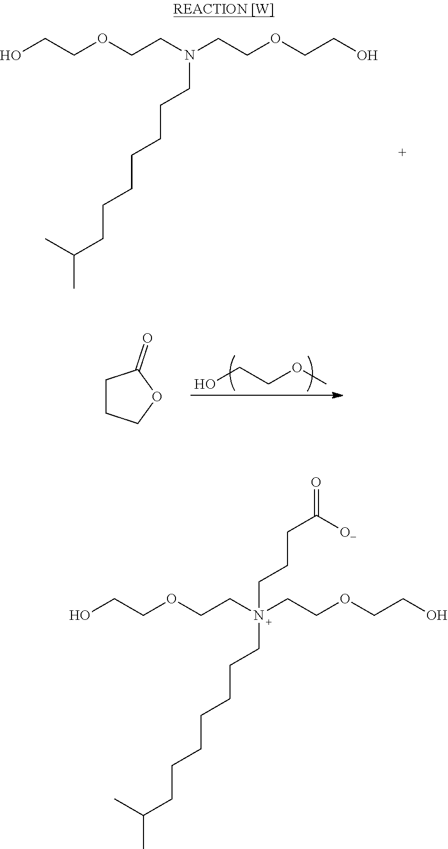

### Examples 15-17

The sulfobetaine blends of EXAMPLES 11, 12, and 13 were mixed with 4,4′-methylene diphenyl diisocyanate (“MDI”) (sold under the trade name LUPRANAT MM 103 by BASF), a poly(ethylene/propylene oxide) polyol (sold under the trade name PLURACOL 220 by BASF), and in the case of EXAMPLE 17, with additional polyethylene glycol (CARBOX 1000, sold by Dow Chemical Co.) to form various prepolymer blends. The specific combination of each component is provided in TABLE 3 below, along with the weight percentage of sulfonate groups (e.g., —SO³⁻) in the prepolymer blend, and the ratio of NCO groups to OH groups in the prepolymer blend.

### Comparative Examples 18-20

Various comparative foam formulations were also prepared in order to compare foams made from the sulfobetaine-modified precursor compounds formed in EXAMPLES 15-17 with a comparable foam made from an un-modified precursor compound (e.g., made without an ionic modifier, COMPARATIVE EXAMPLE 18), and anionic-modified foam formed from an anionic-modified precursor compound (also referred to herein as a “T-600 Polyol”) which is described in U.S. Pat. No. 4,638,017, titled “HYDROPHILIC POLYURETHANE/POLYUREA SPONGE,” issued on Jan. 20, 1987.

TABLE 3
Summary of Pre-Polymer Blend Formulations

| | Amount in Pre-Polymer Blend (g) | | | | | |
|---|---|---|---|---|---|---|
| | | | | Comp. | Comp. | Comp. |
| | Example | Example | Example | Example | Example | Example |
| | 15 | 16 | 17 | 18 | 19 | 20 |
| Lupranate MM103 | 140 | 125 | 150 | 125 | 125 | 125 |
| Pluracol 220 | 150 | 150 | 150 | 150 | 150 | 150 |
| Carbowax 600 | — | — | — | 65 | 45 | — |
| Example 11 Blend | 65 | — | — | — | — | — |
| Example 12 Blend | — | 42.5 | — | — | — | — |
| Carbowax 1000 | — | 22.5 | — | — | — | — |
| Example 13 Blend | — | — | 65 | — | — | — |
| T-600 Polyol | — | — | — | — | 20 | 65 |
| % SO3 | 0.80 | 0.82 | 1.86 | 0 | 0.35 | 1.36 |
| NCO/OH Ratio | 2.94 | 2.88 | 2.71 | 2.94 | 3.09 | 3.50 |

Foams Formed from the Prepolymers

Each prepolymer blend of EXAMPLES 15-17 and COMPARATIVE EXAMPLES 18-20 were each mixed into a foaming composition in order to form a corresponding polyurethane-based foam. Each foaming composition included 30 g of the prepolymer blends of EXAMPLES 15-17 and COMPARATIVE EXAMPLES 18-20. 2 g of water (H₂O), 0.12 g of 2,2′-dimorpholinildiethylether (DMDEE), 1.6 g of Tegostab 8404 B, 3 g of a 6% (w/w) solution of Aqualon CMC 7L, and 0.04 g of Metatin 740. Each foaming composition was then converted to a foam using known foaming methods. Each resulting foam was then tested for various mechanical properties and water-affinity properties. The same mechanical and water-affinity properties were also measured for a conventional cellulose-based sponge and for a modified urethane foam made by incorporating sulphonate groups into the polymer backbone through the transesterification of dimethyl sodium 5-sulfoisophthalate with polymeric glycols to create a ion containing polyol (as described in more detail in U.S. Patent Application Publication No. 2017/0245724 A1, titled “HYDROPHILIC OPEN CELL FOAM,” published on Aug. 32, 2017 (also referred to herein as the “Hydra” foam)). The results of these tests are shown in TABLE 4.

TABLE 4
Summarized Physical Property Testing of Foams

| e | Example 15 | Example 16 | Example 17 |
|---|---|---|---|
| % SO3 | 0.80 | 0.82 | 1.86 |
| NCO/OH Ratio | 2.94 | 2.88 | 2.71 |
| Tensile Strength (psi) | 19.22 | 19.5 | 21.0 |
| Compression (lbs) | 2.3 | 2.6 | 2.8 |
| Density (lbs/ft³) | 3.48 | 3.57 | 3.44 |
| % Swell | 8.28 | 13.91 | 10.3 |
| Water holding (g H₂O/g foam) | 3.27 | 3.09 | 3.32 |
| Wet out time (s) | 4 | 5 | <1 |

| | Comp | Comp | Comp | | |
|---|---|---|---|---|---|
| Property | Example 18 | Example 19 | Example 20 | Hydra | Cellulose |
| % SO3 | 0 | 0.35 | 1.26 | 2.99 | — |
| NCO/OH Ratio | 2.94 | 3.09 | 3.50 | 3.11 | — |
| Tensile Strength (psi) | 14.13 | 18.75 | 24.7 | 15.96 | — |
| Compression (lbs) | 1.5 | 1.7 | 1.9 | 3.1 | 1.9 |
| Density (lbs/ft³) | 3.46 | 3.72 | 3.85 | 5.35 | 3.76 |
| % Swell | 1.08 | 7.08 | 14.77 | 25.07 | 55.54 |
| Water holding (g H₂O/g foam) | 2.35 | 2.38 | 2.94 | 3.25 | 3.86 |
| Wet out time (s) | 8 | 5.5 | <1 | 2 | <1 |

As can be seen from TABLE 4, the foams show a positive correlation between tensile strength and the ionic content for both the sulfobetaine modified foams (EXAMPLES 15-17) and for the T-600 anionic modified foams (COMPARATIVE EXAMPLES 19 and 20). This is typical behavior for ion-containing polymeric systems, where typically as the ionic content increases, the ionic aggregation increases and acts to crosslink the matrix.

Density values for all of the foams are consistent with that of cellulose, which can be useful if these materials are deployed in cellulose dominated markets.

As reported in Table 4, the results for percentage swell are, on average, much lower for the sulfobetaine-modified sponges of EXAMPLES 15-17 as compared to existing sponge compositions (e.g., to the cellulose and hydra sponges), which may present a processing advantage when laminating on rigid, or flat substrates that are susceptible to wrinkling. Current lamination techniques require the sponge to be hydrated for dimensional control, which can present process control limitations and microbial contamination susceptibility.

The water holding test also shows that as the ionic content increases so too does the sponge's ability to hold water. On a density corrected basis (i.e. volumetric basis), the sulfobetaine-modified foams of EXAMPLES 15-17 absorbed more water than the anionic-modified (T-600) foams, since they pick up more water with less dense foams.

Wet-out time was also found to have a positive correlation to ionic content for both the T-600 anionic-modified foam of COMPARATIVE EXAMPLES 19 and 20 and for the sulfobetaine-modified foams of EXAMPLES 15-17. As the composition shifts to higher levels of ionomer, the wet-out time reduces, and achieves essentially instantaneous wet-out at 18 wt. % for the anionic T-600 system (COMPARATIVE EXAMPLE 20) and at 13 wt % for the sulfobetaine system (EXAMPLE 17), which is comparable to cellulose performance, as shown in TABLE 4.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A hydrophilic foam comprising a polymer formed from a betaine prepolymer that is a reaction product of a betaine of formula (I) with one or more polyether glycols and a polyfunctional isocyanate compound of formula (II), 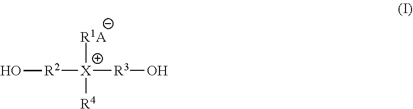
wherein R¹, R², R³, and R⁴ are each hydrocarbon groups having from 1 to 4 carbon atoms, A⁻ is an anionic functional group, and X⁺ is a cationic atom,
OCN—R⁵—(NCO)_{b} (II)
wherein R⁵ is a linear or branched aliphatic hydrocarbon group having from 2 to 12 carbon atoms, or a 5- or 6-membered aliphatic or aromatic carbocyclic group having from 5 to 50 carbon atoms, and
b is an integer having a value of 1, 2, or 3.

2. A hydrophilic foam according to claim 1, wherein X⁺ is a nitrogen cation (N⁺) or a phosphorus cation (P⁺).

3. A hydrophilic foam according to claim 1, wherein A⁻ includes a sulfonate anion group (SO₃⁻), a carboxylate anion group (COO⁻), or a phosphonate anion group (PO₄⁻).

4. A hydrophilic foam according to claim 1, wherein R¹ is an n-propyl group (—(CH₂)₃—).

5. A hydrophilic foam according to claim 1, wherein one or more of R², and R³, and R⁴ comprise an alkoxylated group having formula (II):
((CH₂)ₙO)ₘH (II)
wherein m is an integer from 1 to 5, and
n is 2, 3, or 4.

6. A hydrophilic foam according to claim 1, wherein R⁴ is an ether group of formula (IV):
—R⁶—O—R⁷ (IV)
wherein R⁶ is a linear aliphatic hydrocarbon group having from 1 to 20 carbon atoms, and
R⁷ is a linear, branched, substituted, or unsubstituted hydrocarbon having from 1 to 20 carbon atoms.

7. A hydrophilic foam according to claim 1, wherein the one or more polyether glycols comprise poly(ethylene glycol) of formula (V):

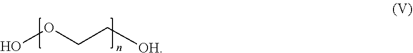

8. A hydrophilic foam according to claim 1, wherein the one or more polyether glycols comprise a poly(ethylene glycol) and poly(propylene glycol) block copolymer of formula (VI):

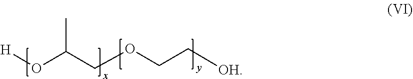

9. A hydrophilic foam comprising a polymer formed from a betaine prepolymer of formula (I): 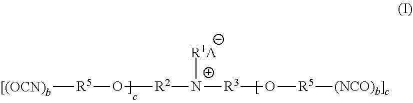
wherein A⁻ is an anionic functional group,
R¹, R², and R³ are each hydrocarbon groups having from 1 to 4 carbon atoms,
R⁵ is a linear or branched aliphatic hydrocarbon group having from 2 to 12 carbon atoms, or a 5- or 6-membered aliphatic or aromatic carbocyclic group having from 5 to 50 carbon atoms,
b is an integer having a value of 1, 2, or 3, and
c is the degree of polymerization of the betaine prepolymer, which is an integer having a value of 1-5.

10. A hydrophilic foam according to claim 9, wherein A⁻ includes a sulfonate anion group (SO₃⁻), a carboxylate anion group (COO⁻), or a phosphonate anion group (PO₄⁻).

11. A hydrophilic foam according to either claim 9, wherein R¹ is an n-propyl group (—(CH₂)₃—).

12. A hydrophilic foam according to claim 9, wherein one or both of R² and R³ comprise an alkoxylated group having formula (II):
((CH₂)ₙO)ₘH (II)
wherein m is an integer from 1 to 5, and
n is 2, 3, or 4.

13. A hydrophilic foam according to claim 9, wherein one or both of R² and R³ comprise an ethoxylated group having formula (III):
—((CH₂CH₂O)ₘH (III)
wherein m is an integer from 1 to 5.

14. A method comprising the steps of:
(a) reacting a betaine of formula (I) with one or more polyether glycols and a polyfunctional isocyanate compound of formula (II) to provide a hydrophilic prepolymer, 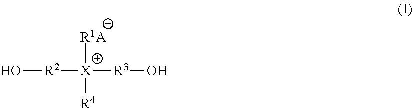
wherein R¹, R², R³, and R⁴ are each hydrocarbon groups having from 1 to 4 carbon atoms,
A⁻ is an anionic functional group, and
X⁺ is a cationic atom,
OCN—R⁵—(NCO)_{b} (II)
wherein R⁵ is a is a linear or branched aliphatic hydrocarbon group having from 2 to 12 carbon atoms, or a 5- or 6-membered aliphatic or aromatic carbocyclic group having from 5 to 50 carbon atoms, and
b is an integer having a value of 1, 2, or 3;
(b) polymerizing and foaming the hydrophilic prepolymer of step (a) to provide a hydrophilic foam.

15. A method according to claim 14, wherein X⁺ is a nitrogen cation (N⁺) or a phosphorus cation (P⁺).

16. A method according to claim 14, wherein one or more of R², and R³, and R⁴ comprise an alkoxylated group having formula (III):
((CH₂)ₙO)ₘH (III)
wherein m is an integer from 1 to 5, and
n is 2, 3, or 4.

17. A method according to am claim 14, wherein R⁴ is an ether group of formula (IV):
—R⁶—O—R⁷ (IV)
wherein R⁶ is a linear aliphatic hydrocarbon group having from 1 to 20 carbon atoms, and
R⁷ is a linear, branched, substituted, or unsubstituted hydrocarbon having from 1 to 20 carbon atoms.

18. A method according to claim 14, wherein the betaine of formula (I) and the polyfunctional isocyanate compound of formula (II) in step (a) are dissolved in a solvent comprising at least one of the one or more polyether glycols.

19-33. (canceled)
